(19) United States
(12) Patent Application Publication
(10) Pub. No.: US 2007/0008287 A1
(43) Pub. Date: Jan. 11, 2007

(54) Personalized handset keyboard symbols input system and method thereof

(76) Inventor: Bing-Sheng Lin, Taipei (TW)

Correspondence Address: HARNESS, DICKEY & PIERCE, P.L.C., P.O. BOX 8910, RESTON, VA, 20195, US

(21) Appl. No.: 11/174,587

(22) Filed: Jul. 6, 2005

(51) Int. Cl. G09G 5/00

(52) U.S. Cl. 345/168

(57) ABSTRACT

A personalized handset keyboard symbols input system and method thereof, which can be utilized to execute a keyboard symbol correspondence program and generate the corresponding relation setting between the respective keyboard symbol and the combined key signal as redefined by the user, and then store settings into a keyboard symbol correspondence setting data base. The user may input the data according to the keyboard symbol correspondence relations s/he is used to the next time s/he executes the keyboard symbol correspondence program.

### BACKGROUND OF THE INVENTION

1. Field of the Invention

The invention relates to a system of redefining keyboard symbols and a method thereof, and in particular to a system and method of redefining the combined key signals corresponding to the respective keyboard symbols utilized on the telephone dial or keyboard having a few keys used for input.

2. Related Art

According to statistics released in 2002, the popularity rate of mobile phones in Taiwan has reached as high as 100.7%, namely, on the average, each person in Taiwan has more than 1 mobile phone. This popularity rate exceeds that of the ordinary household fixed type telephone, thereby making the mobile phone utilization rate number one in the world, which highlights the importance of mobile phones in our daily lives.

In general, the most frequently utilized sales promotion method of mobile phone dealers and service providers is that the new phone number application or the existing phone number continuation contract includes a free handset discount when purchasing a new handset in renewing the contract. This kind of sales promotion is intended to take advantage of the user's preference for the new fashioned handset having new functions. As such, upon the termination of the contract of the mobile phone service, the ordinary user takes this opportunity to get a new handset, especially in the case that the handset provided by the service provider is cheap and of superior quality and performance, so that the user is willing to spend a certain amount of money to have this improved service. For instance, the handset of the original brand or version has the benefit of providing long hours of system readiness, yet its multimedia functions are missing. Thus, under this circumstance, the user is willing to replace the original handset with a new one that can take pictures and receive music played by MP3. If the user is a businessman on the move and his original handset is only capable of double frequency communication, once he travels abroad on business trip he has to carry an additional handset with channel communication capability of the frequency used abroad, thus incurring additional cost and inconvenience. In this condition, it is better that his original handset be replaced by the new one having four channel communication capabilities to suit the actual requirements.

Since the handsets produced by the various manufacturers have their merits and drawbacks respectively, in replacing the original handset the user does not have to stick to the original version or manufacturer. In certain circumstances the change of the handset to that produced by a different manufacturer may be more suitable for the actual requirements of the user. However, it doing so, he might be faced with a very common problem that the symbol arrangements on the keyboards or dials of the handsets of different manufactures are quite different.

A handset is a tool used to talk to when making a telephone call, while the keyboard (or dial) is used for inputting the digits of the telephone number 0, 1, 2, . . . , 9 for the telephone call. In addition, short message transmission is one of the major functions of the handset. For the handset with English characters, since the arrangement of the English characters on the keyboards of handset are almost the same for the various manufacturers, the change of handsets usually will not lead to the change of the manner of inputting characters on the keyboard except if the digits/characters on the dial are arranged circularly rather than in the traditional 3-column by 4-row manner. However, for the handset with Chinese characters, the character arrangements on the keyboards are not quite the same for the handsets produced by different manufacturers. Even for two different versions of handsets produced by the same manufacturer, the arrangements of the Chinese characters on the respective keyboards may be quite different. For instance, the introduction and inclusion of the intelligent input method to facilitate user's input may lead to the rearrangement of the phonetic marks on the keyboard, thus creating inconvenience for the user used to the keyboard phonetic mark arrangement of the old version handset.

### SUMMARY OF THE INVENTION

In view of the above-mentioned problems and shortcomings of the prior art, the object of the invention is to provide a personalized handset keyboard symbol input system and method thereof, so that the user does not have to readjust and readapt himself to the new arrangement of symbols on the keyboard.

To achieve the objective of the invention, the personalized handset keyboard symbol input system includes at least the following devices: an input interface, which is used to provide a display interface for guiding the user to input the resetting of the keyboard symbols; a setting module, which is used to receive and store the resetting of the keyboard input by the user; a keyboard symbol correspondence setting database, which is used to store the keyboard symbol and the corresponding combined key signals; and a conversion module, which is used to convert the combined key signals input by the user to the new keyboard symbol display according to the set correspondence relations.

In order to enable the user to input character and data according to keyboard symbol arrangement he is used to, the user must first set the keyboard symbol and the corresponding combined key signals. The setting method comprises the following steps: first, the user executes the keyboard symbol correspondence program. Next, displaying the input interface. Then, receiving the input combined key signals input by the user according to the instructions shown on the display interface. Subsequently, when reading “*”, storing the string of combined key signals input previously by the user into the field of “new combined key signals.” Then reminding the user to input the corresponding key, and starting to read the combined key signals input by the user. Next, when reading “#”, storing the string of combined key signals input previously by the user into the field of “keyboard symbol.” Complete all the desired revisions of the keyboard symbol and the corresponding new combined key signals setting. Then, reminding the user to input the name of the file to be stored, then receiving the file name input by the user. And finally, store the set keyboard symbol correspondence table having the file name in the data base.

In addition, upon setting the new correspondence relations of the keyboard symbol by the user the method further comprises: First, receiving the setting of the keyboard symbol to be changed and input by the user. Next, determining whether the keyboard symbol correspondence program has been executed. Subsequently, if the program has not been executed and when the combined key signals are input by the user, reading the keyboard symbols set by the manufacturer for the corresponding output display; otherwise, reading the keyboard symbol correspondence table selected by the user. Then receiving a set of transmitted combined key signals. Inquiring the user set corresponding keyboard symbol according to the set of combined key signals. And finally, displaying the keyboard symbols in the screen.

Further scope of the applicability of the invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The invention will become more fully understood from the detailed description given below, which is for illustration only and thus is not limitative of the invention, wherein:

FIG. 1 is a schematic diagram of the system structure of the personalized handset keyboard symbol input system according to the invention;

FIG. 2 is a flowchart of the input interface setting guidance process of the personalized handset keyboard symbol input method according to the embodiment of the invention;

FIG. 3 is a comparison of the original correspondence relations between the original combined key signals and the displayed keyboard symbols vs. the new correspondence relations between the new combined key signals and the displayed keyboard symbols according to the embodiment of the invention;

FIG. 4 is a flowchart of the process of setting the correspondence table indicating the relations between the keyboard symbols and the combined key signals according to the embodiment of the invention; and

FIG. 5 is a flowchart of the personalized handset keyboard symbol input method according to the embodiment of the invention.

### DETAILED DESCRIPTION OF THE INVENTION

The purpose, construction, features, and functions of the invention can be appreciated and understood more thoroughly through the following detailed description with reference to the attached drawings.

The invention relates to a personalized handset keyboard symbol input system and a method thereof. In the following description, the various specific details of the invention are described to provide a completion understanding of the invention. However, to the person familiar with the art, the invention can be realized without requiring such specific details, or it can be implemented with alternative elements or methods. In certain circumstance, the known methods, procedures, elements, and circuits are not described in detail, so as not to unnecessarily obscure the essence of the invention.

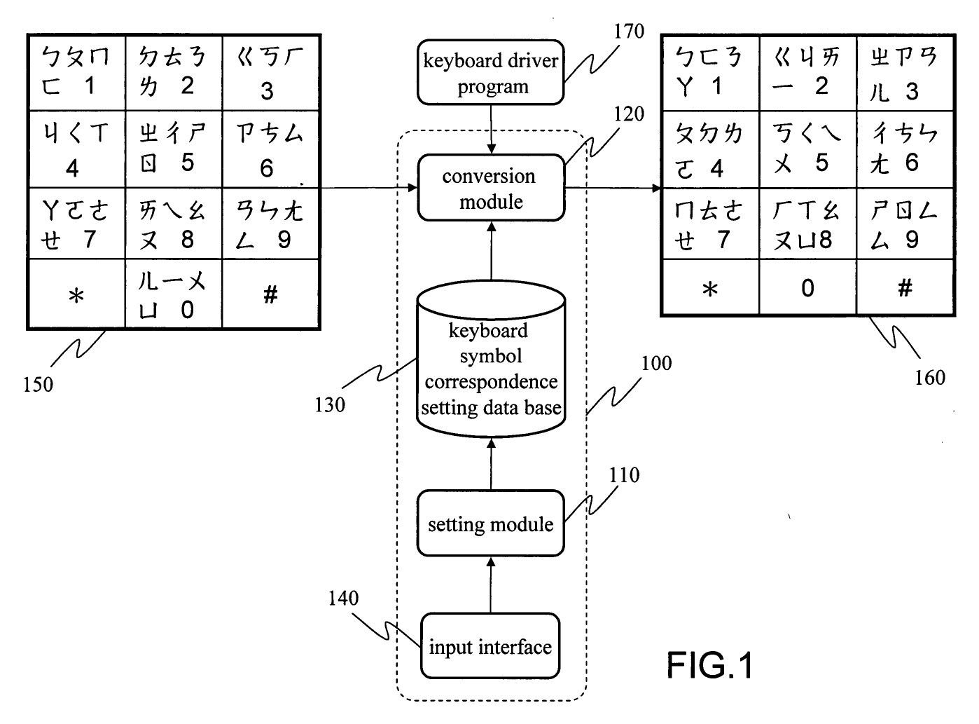

Refer to FIG. 1 for a schematic diagram of the system structure of the personalized handset keyboard symbol input system of the invention, in which the portion enclosed in the dashed line is the keyboard symbol correspondence program 100, including the following four major components:

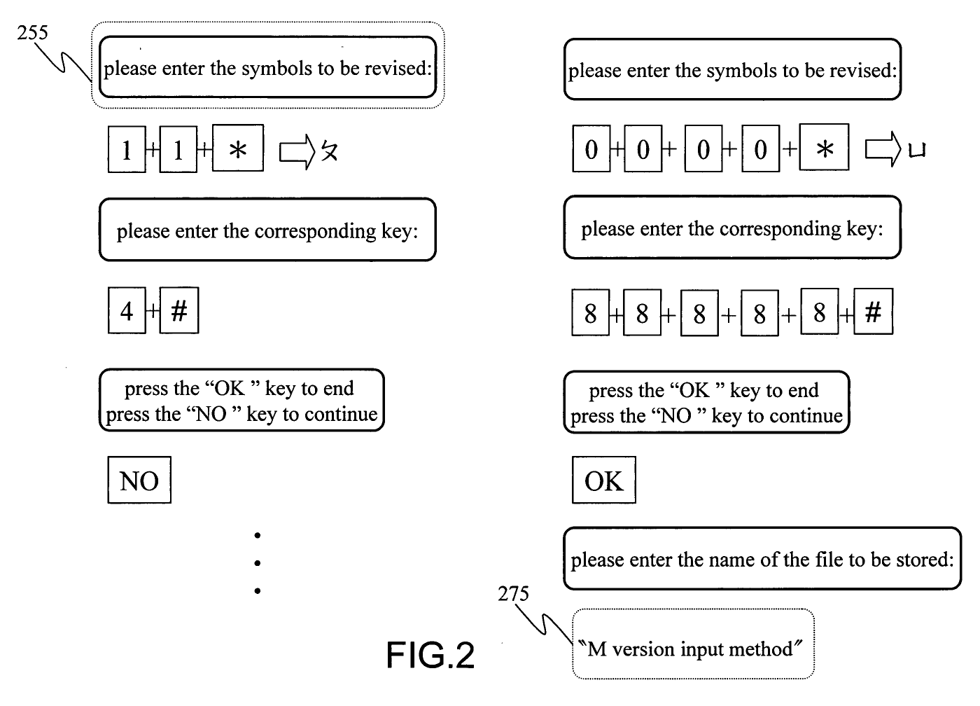

Firstly, an input interface 140, which is displayed on the screen of the handset, and is used to provide an outside display interface for guiding the user to input the new correspondence relation of the keyboard symbol 150. As shown in FIG. 2, the interface can be used to display the various guidance and explanatory sentences, thus guiding the user to complete the setting of the new keyboard symbol 160. For example, the various instruction sentences 255 can be: “please enter the symbols to be revised.” “please enter the corresponding key,” “press the “OK” key to end,” “press the “NO key” to continue,” and “please enter the name of the file to be stored.”

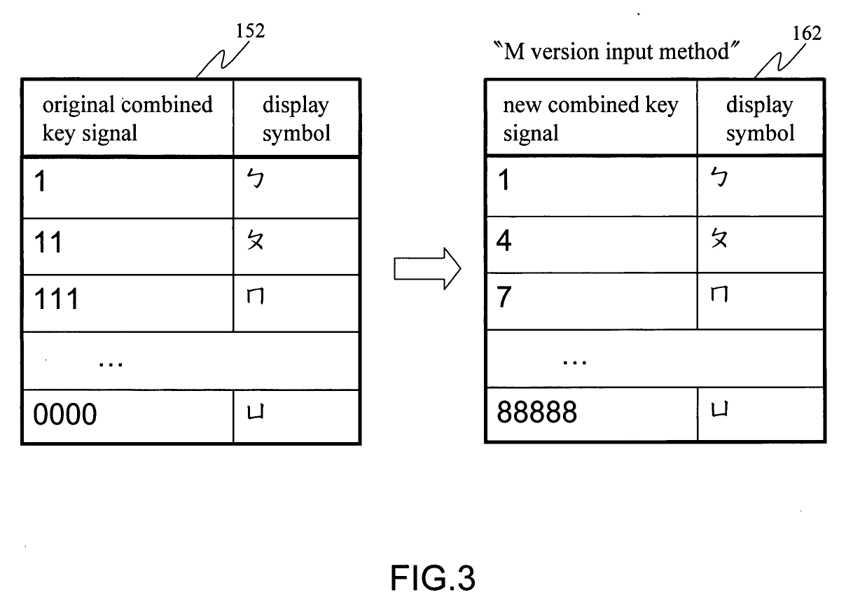

Secondly, the setting module 110, which is used to receive the key signal input by the user and add a new correspondence table 162 storing the new settings of the keyboard symbol 150 when the combined key signals is input by the user according to the instructions. For more detailed description please refer to FIG. 3. The correspondence table shown on the left side of the figure is the original keyboard symbol correspondence table 152 set by the manufacturer. The original keyboard symbol arrangement 150 set by the manufacturer is: “ [symbol] ” at key “1,” “ [symbol] ” at key “2,” and the rest can be inferred in the same manner. Therefore, when this arrangement is used to correspond to the original keyboard symbol correspondence table 152, the keyboard symbol “ [symbol] ” corresponds to the original combined key signals “1,” which means pressing key “1” once; the keyboard symbol “ [symbol] ” corresponds to the original combined key signal “11,” which means pressing key “1” twice, and the rest can by inferred in the same manner. As such, the keyboard symbol “ [symbol] ” corresponds to the original combined key signals “0000,” which means pressing key “0” four times.

Furthermore, on the right side of FIG. 3 is shown the keyboard symbol arrangement 160 reset by the user, in which the keyboard symbols corresponding to key “1” are “ [symbol] ,” the keyboard symbols corresponding to key “2” are “ [symbol] ” and the keyboard symbols corresponding to key “9” are “ [symbol] .” As such, in the newly added correspondence table 162, the keyboard symbol “ [symbol] ” still keeps its original correspondence relation, and there is no need for additional setting, while keyboard symbol “ [symbol] ” corresponds to the new combined key signals “4,” which means pressing key “4” once, and the rest can be inferred in the same manner. Keyboard symbol “ [symbol] ” corresponds to the new combined key signal “88888,” which means pressing key “8” five times.

Upon completion of the resetting the keyboard symbols, entering the file name 275 of the newly set keyboard symbols and storing it into the memory. The next time the user performs the actions of sending out the short messages or compiling the telephone directory and requiring the input of the Chinese characters by making use of the phonetic marks, and then this new correspondence table is used to retrieve the keyboard symbol corresponding to the string of combined key signals input by the user.

Thirdly, the keyboard symbol correspondence setting data base 130, which is used to store the correspondence file of the various previously set keyboard symbol and the corresponding combined key signals, or the patterns of the correspondence relations between the various keyboard symbols and the combined key signal downloaded by the user, or the patterns of the various built-in correspondence relations set by the manufacturer. These correspondence files or patterns are recorded in the Non-Volatile RAM (NVRAM), and as such the data stored therein will not be lost when the handset runs out of power. The Non-Volatile RAM (NVRAM) utilized herein includes the Electrically Erasable Programmable Read-Only Memory (EEPROM), Erasable Programmable Read-Only Memory (EPROM), or flash memory.

Fourthly, the invention includes a conversion module 120, which is used to combine the key signals received by the keyboard driver program 170 as input by the user, and to inquire into the correspondence table set by the user, thereby converting the combined key signals into the newly set keyboard symbols according to the correspondence relations. For example, when the user makes use of the “M version input method” as the corresponding basis and input the key signal of key “4,” then this module is utilized to find its corresponding keyboard symbol “ [symbol] ” through the correspondence table; otherwise, the keyboard symbol “ [symbol] ” is displayed directly without any conversion.

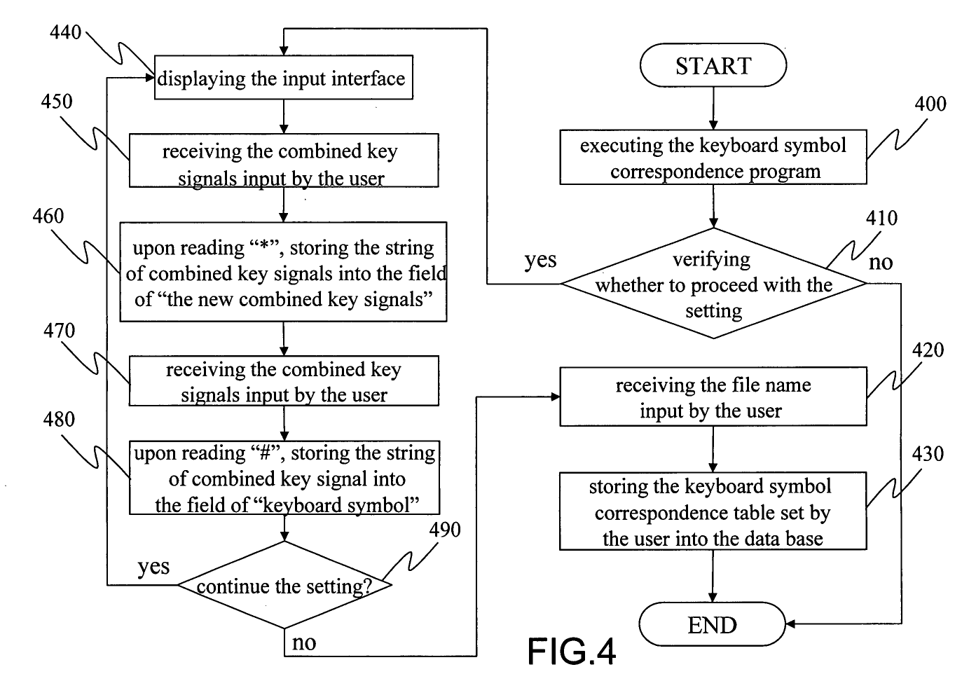

Therefore, if the user inputs the Chinese phonetic marks according to the keyboard symbol arrangement 160 of his own preference, then he must first set the keyboard symbol and its corresponding combined key signal. In this regard, please refer to FIG. 4, which shows the flowchart of the method of setting the correspondence table indicating the relations between the keyboard symbols and the combined key signals. The method includes the following steps: Firstly, the user executes the keyboard symbol correspondence program 100 (step 400).

Next, determining if the user indeed desires to proceed with the setting (step 410), if the answer is affirmative, then displaying the input interface 140 (step 440); otherwise, the process flow is ended. Then, the setting module 110 is used to receive the combined key signals input by the user according to the instructions 255 as shown on the input interface 140 (step 450). Moreover, upon reading “*” or other certification key signal, storing the string of combined key signals input previously by the user into the field of “the new combined key signals” (step 460).

Next, reminding the user to input the corresponding key signal, which will be read when the user presses the key (step 470). Then, upon reading “#” or other certification key signal, storing the string of combined key signals previously input by the user into the field of “the keyboard symbol” (step 480), thus completing the setting of the keyboard symbol. Next, it is determined if the user would like to continue the setting process (step 490). Subsequently, upon verifying that the user has completed all the settings of keyboard symbols to be changed and their corresponding new combined key signal s, then reminding the user to input the name of the file to be stored and receiving the file name 275 input by the user (step 420).

Finally, storing the set keyboard symbol correspondence table 160 having the file name into the keyboard symbol correspondence setting data base 130 (step 430), thus completing the process of setting the keyboard symbols. The above-mentioned steps 450 and 460 may be exchanged with steps 470 and 480 according to the instructions and the guidance as shown in the input interface 140, and will not affect the result of the implementation of the invention.

For more concrete description and better understanding of the above-mentioned keyboard symbol setting process, please refer to FIG. 2. Firstly, upon the activation of the keyboard symbol correspondence program 100 by the user, the reminding instruction 255 of “please input the symbol to be revised” is displayed in the input interface 140. If at this time the keyboard symbol to be revised is “ [symbol] ,” then according to the originally manufacturer set keyboard symbol arrangement 150, the combined key signals corresponding to “ [symbol] ” is “11,” which means pressing key “1” consecutively two times, and then adding the symbol “*” to inform the system that the keyboard symbol “ [symbol] ” has been selected. Then the reminding instruction of “please input the corresponding key” is displayed in the input interface 140, assuming that the key to correspond to is key “4,” then pressing key “4” and adding “#” to certify that the corresponding combined key signals has been selected. And then, the reminding instruction of “press “OK key” to end, press “NO key” to continue” is displayed in the input interface 140. Under this circumstance, if the “NO key” is input by the user, then the process continues to set other keyboard symbols to be revised, until the “OK key” is input by the user to end the keyboard symbol setting process.

And finally, the reminding instruction of “please enter the name of the file to be stored” is displayed in the input interface 140 to remind the user to input the name of the file to be stored. In this embodiment, the file name desired to be used is the “M version input method.” The correspondence table of the previously set keyboard symbols and the combined key signals is stored in the keyboard symbol correspondence setting data base 130 in the file name of “M version input method.”

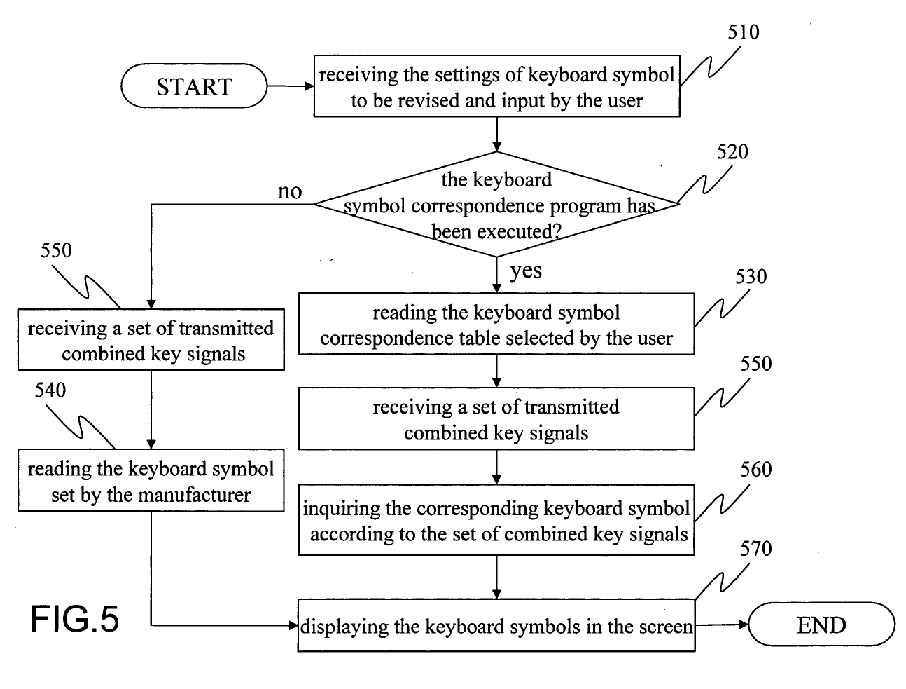

More specifically, upon setting the new corresponding relations' of keyboard symbols, the new corresponding relations can be utilized to input data by making use of the new handset. For more detailed description, please refer to FIG. 5 for the flowchart of the process of the personalized handset keyboard symbol input method according to the embodiment of the invention, which includes the following steps: Firstly, receiving an indication that the user wishes to input Chinese characters through the phonetic marks by making use of the settings of the keyboard symbols (step 510).

For instance, the user inputs the information in Chinese such as: compiling the short messages or inputting the name and the address of a person in the telephone directory, thus switching the input mode to the phonetic marks input mode. Next, it is determined whether the keyboard symbol correspondence program 100 is activated (step 520). If the answer is negative, then the keyboard symbol 150 set by the manufacturer is read directly to make the corresponding output display when the combined key signals is input by the user (step 540). Otherwise, the keyboard symbol correspondence table 160 is read from the keyboard symbol correspondence setting data base 130 (step 530).

Then, receiving a set of combined key signals transmitted from the keyboard driver program 170. Subsequently, inquiring the corresponding keyboard symbol set by the user according to the set of combined key signals (step 560). And finally, displaying the keyboard symbols in the screen (step 570) or providing it to the application program for utilizing it in the processing of the Chinese character information, such as: the compiling short messages, setting personal schedules, taking notes, inputting names, companies, the addresses, addendums etc.

In addition, the contents of FIG. 3 are taken as an example for further description of the personalized handset keyboard symbol input method according to the embodiment of the invention. Assuming that the “M version input method” 162 is selected for keyboard symbol conversion, and the keyboard symbol correspondence program 100 is activated while inputting the short message, when “88888” is input by the user it is converted and displayed as the corresponding keyboard symbol “ [symbol] ” through the new correspondence table 162. Similarly, if inputting the Chinese character “ [symbol] ,” and if the intelligent input method is utilized, then when key “8” and key “3” are input sequentially by the user, then only “ [symbol] ” and “ [symbol] ” are displayed for further selection by the user.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A personalized handset keyboard symbols input system, comprising:
an input interface, which provides an outside displaying interface for guiding a user to input an operation instruction relating to a keyboard symbol conversion;
a setting module, which receives the operation instruction and stores a resetting of the respective keyboard symbols made by the user as contained in the operation instruction;
a keyboard symbol correspondence setting data base, which stores a correspondence table of the keyboard symbols and a plurality of combined key signals according to the operation instruction; and
a conversion module, which converts a plurality of combined key signals into the respective corresponding keyboard symbol according to the correspondence table to display.

2. The system of claim 1, wherein the keyboard symbol correspondence setting data base is stored in a Non-Volatile RAM (NVRAM).

3. The system of claim 1, wherein the keyboard symbols are phonetic symbols.

4. The system of claim 1, wherein the combined key signals comprises more than one same key signal.

5. A personalized handset keyboard symbols input method, which is realized through a keyboard symbol correspondence program, the method comprising the following steps:
activating the keyboard symbol correspondence program;
reading a keyboard symbol correspondence table selected by an user;
receiving a plurality of combined key signals input by the user; and
inquiring a keyboard symbol set by the user corresponding to the combined key signals.

6. The method of claim 5, wherein the keyboard symbol correspondence table is set by a setting method, comprising the following steps:
displaying a first hint to guide the user to input a keyboard symbol desired to be revised;
receiving a first terminating signal, and storing the combined key signal corresponding to the keyboard symbol in a first field of the correspondence table;
displaying a second hint to guide the user to input a new combined key signal corresponding to the keyboard symbol input by the user;
receiving a second terminating signal, and storing the new combined key signal in a second field of the correspondence table;
displaying a hint to guide the user to input a name of a file desired to be stored; and
storing the correspondence table in the name of the file.

7. The method of claim 5, wherein the keyboard symbol correspondence table is stored in a keyboard symbol correspondence setting data base.

8. The method of claim 7, wherein the keyboard symbol correspondence setting data base is stored in a Non-Volatile RAM (NVRAM).

9. The method of claim 5, wherein the keyboard symbol correspondence table is provided with a plurality of correspondence relations between the combined key signals of keyboard symbols set by the manufacturer and the combined key signals of the keyboard symbols set by the user.

10. The method of claim 5, wherein the keyboard symbols are phonetic symbols.

11. The method of claim 5, wherein the combined key signals comprises more than one same key signal.
